(19) United States
(12) Patent Application Publication
(10) Pub. No.: US 2023/0399491 A1
(43) Pub. Date: Dec. 14, 2023

(54) Bifunctional Surface for Antimicrobial Applications

(71) Applicants: TE Connectivity Solutions GmbH, Schaffhausen (CH); Tyco Electronics UK Ltd., Swindon (GB)

(72) Inventors: Lei WANG, San Jose, CA (US); Yiliang WU, San Ramon, CA (US); Ting GAO, Palo Alto, CA (US); Kaylie Jane SMITH, Oxford (GB)

(73) Assignees: TE Connectivity Solutions GmbH, Schaffhausen (CH); Tyco Electronics UK Ltd, Swindon (GB)

(21) Appl. No.: 17/750,789

(22) Filed: May 23, 2022

(51) Int. Cl. C08K 5/00; C08L 23/08; B32B 27/20; B32B 27/32; B41M 5/52; C08K 3/016; B32B 27/08

(52) U.S. Cl. CPC C08K 5/0058; C08L 23/0853; B32B 27/20; B32B 27/08; B41M 5/52; C08K 3/016; B32B 27/32

(57) ABSTRACT

An bifunctional surface for antimicrobial applications is described. The bifunctional surface comprises a polymer composite comprising of a mixtures of a polymer, at least one antimicrobial additive and an optional hydrophobic additive.

### FIELD OF THE INVENTION

The present invention is directed to a bifunctional surface for antimicrobial applications. The bifunctional surface has a micro- or nano-textured surface. Using this bifunctional approach, the surface can prevent bacteria from adhering to the surface as well as killing any bacteria which may attach to the surface.

### BACKGROUND OF THE INVENTION

Antimicrobials are chemical compounds that reduce and/or mitigate the growth or development of microbial organisms. Antimicrobial additives work by a variety of mechanisms dependent upon the mode of action, composition, degree of activity, and application. When used properly, antimicrobial compounds lead to the death or arrested growth of the targeted microorganisms. Since their discovery in the early 1900s, antimicrobials have transformed the prevention and treatment of infectious diseases. Antimicrobial additives are currently used across a very wide array of applications, including the use of antimicrobials in the polymeric materials used in various consumer products, packaging materials, medical applications and any other application or article in which human contact is experienced. For example, polymeric materials that include antimicrobial additives can be used to make articles and devices that will then eliminate, reduce and/or mitigate the growth or development of microbial organisms.

However, antimicrobials may also be hazardous to human health. Therefore, there is a need for antimicrobial additives that do not leach out of the materials in which they are used. Further there is a need for antimicrobial additives which do not leach out of the materials in which they are used and which remain effective over the life of usage of the material, or the article or device made from the material in which the antimicrobial additive is used.

Ideally, the antimicrobial agents that provide these non-leaching antimicrobial properties would have a proven history of use and effective activity against various microorganisms without any adverse effect on person using the product. The antimicrobial material, or other materials containing the antimicrobial additive, should be applicable to products and/or surfaces thereof by commercially-viable manufacturing methods such as molding, extrusion, and ail other methods of processing polymeric materials. In addition, the antimicrobial additive should not interfere with the physiochemical and/or mechanical properties of the treated material, product and/or surface there.

One approach to reduce microbial contamination is to develop surfaces with bactericidal activity, for example by making or coating the surface with a material that will release antimicrobial compounds. Almost all treatments fall into one of the following three categories: 1) adsorption of the antimicrobial additive into the surface of materials passively or in combination with surfactants or by way of surface-bonded polymers; 2) incorporation of the antimicrobial additive into a polymer coating applied on the material surface; 3) compounding the antimicrobial additive into the bulk material comprising the device.

However, all of these approaches the antimicrobial additive can leach or migrate out of the material in which it has been added. This means the antimicrobial performance of the material is generally dependent on the concentration of the antimicrobial additive (loading) and the rate of its release from the material to which it has been added. It is often very difficult to control the release rate and maintain a constant level of concentration at the surface as the release rate depends on many factors such as actual concentration, solubility, and diffusivity of these active ingredients in the bulk polymer which may also change over the time of use. All of these issues mean approaches based on this leaching mechanism are often ineffective.

The article, “Antimicrobial Polyethylene through Melt Compounding with Quaternary Ammonium Salts” published in the International Journal of Polymer Science in January, 2017, discloses the use of quarternary ammonium salt compounded with polyethylene. The authors observed leaching of samples containing biquats. No leaching was observed with monoquats.

The article, “Recent Developments in Smart Antibacterial Surfaces to Inhibit Biofilm Formation and Bacterial Infections,” published in the Journal of Materials Chemistry B, of the Royal Society of Chemistry in 2018, describe smart antibacterial surfaces that inhibit biofilm formations and bacterial infections.

The article, “Dual-function antibacterial surfaces for biomedical applications,” published in Acta Biomaterilia on Jan. 27, 2015 describes how bacterial attachment and subsequent formation of biofilms on surfaces of synthetic materials pose a problem in both healthcare and industrial applications. The article describes the development of dual function antibacterial surfaces which can kill attached bacteria as well as resist or release bacteria. The authors conclude that further work is necessary in the design and fabrication of such surfaces and the integration of micro- and nano-topography.

U.S. Patent Publication No. 2006/0088678A1 describes a dual ovenable film having a first layer comprising one or more polyamides and a second layer including one or more polyamides. The one or more layers may include one or more additives useful in packaging films, such as, antiblocking agents, slip agents, antifog agents, colorants, pigments, dyes, flavorants, antimicrobial agents, meat preservatives, antioxidants, fillers, radiation stabilizers, and antistatic agents. Such additives, and their effective amounts, are known in the art.

U.S. Patent Publication No. 2007/0166513A1 describes patterned coatings having extreme wetting properties and methods of making. The patent publication describes a patterned surface comprising a substrate supporting a coating include polyelectrolyte multilayer, wherein the surface includes a superhydrophilic region.

U.S. Patent Publication No. 2011/0081530A1 describes a method of manufacturing of an antimicrobial polymeric film. The method comprises coextruding a polymeric substrate layer comprising a first layer of a first polymeric material and a second layer of a second polymeric material wherein the crystalline melt temperature of the second polymeric material is lower than the crystalline melting temperature of the first polymeric material. The coextruded substrate is stretched in a first direction. A polymeric second layer comprising a particulate antimicrobial and liquid vehicles are disposed on the substrate. The stretched film is then heat set. By applying the particulate antimicrobial compound to the coextruded film, it was found that greater antimicrobial activity was obtained.

U.S. Patent Publication No. 2011/022321A1 describes a nanotextured super hydrophobic coating that contains bioactive agents, such as antimicrobials. With the release of the bioactive agent from the coating, reduction of or elimination of bacteria is accomplished.

U.S. Patent Publication No. 2019/0091950A1 teaches a composite having a textured surface with multiple protrusions. The composite can be used as a structural coating or antibacterial material.

U.S. Patent Publication No. 2021/0269656A1 describes an antifouling polymer composite. The composite reduces or eliminates the attachment of biological materials organic materials such as bacteria. The composite comprises a polyurethane polymer and a polysiloxane polymer.

U.S. Pat. No. 8,420,069 B2 describes a polymeric material, methods of making the polymeric material, articles that include the polymeric material, and compositions that contain the polymeric material. The polymeric material can be used to provide coatings that can be antifouling, antimicrobial or both.

U.S. Pat. No. 9,918,466 B2 describes an antimicrobial polymer. The polymer can be produced by the incorporation of an antimicrobial ingredient into the polymer by grafting, copolymerization, or via a combined antimicrobial/plasticizer ingredient. The polymer may be produced as a masterbatch, or a ready to process polymer for producing antimicrobial products. The reactions may be conducted in a reactive extruder to provide a single-step synthesis. Some examples of antimicrobial ingredients that may be bonded include, but are not limited to quaternary ammonium salts, quaternary phosphonium salts, chlorhexidine derivatives, polyhexamethylene biguanide derivatives, povidone iodine, starch-iodine derivatives, and combinations thereof.

U.S. Pat. No. 10,051,867 B2 describes antimicrobial polymer concentrates and compounds. The patent describes antimicrobial masterbatches using migratory assisting agents to improve antimicrobial efficiency. Migratory assisting agents function by carrying the antimicrobial agent while the migratory assisting agent transfers or migrates to the surface of the polymer compound or article. As a result, antimicrobial agents are brought to the surface where there is exposure to bacterial contamination. Antimicrobial agents which can be used are chlorhexidine, chlorhexidine gluconate, glutaral, halazone, hexachlorophene, nitrofurazone, nitromersol, povidone-iodine, thimerosol, parabens, hypochlorite salts, clofucarban, clorophene, poloxamer-iodine, phenolics, mafenide acetate, aminacrine hydrochloride, quaternary ammonium salts, oxychlorosene, metabromsalan, merbromin, dibromsalan, glyceryl laurate, sodium and/or zinc pyrithione, (dodecyl) (diethylenediamine) glycine and/or (dodecyl) (aminopropyl) glycine; phenolic compounds, polymeric guanidines, quaternary ammonium salts, polymyxins, bacitracin, circulin, the octapeptins, lysozmye, lysostaphin, cellulytic enzymes generally, vancomycin, ristocetin, actinoidins, avoparcins, tyrocidin A, gramicidin S, polyoxin D, tunicamycin, neomycin, and streptomycin. Migratory assisting agents are any agents that blooms to the surface.

U.S. Pat. No. 10, 953,432 B2 describes a superhydrophobic surface. The superhydrophobic surface is formed by growing a plurality of etchable, sacrificial structures, and depositing a discontinuous hydrophobic materials onto the sacrificial structures. The discontinuity facilitates etching of the sacrificial structures to remove the grown structures while leaving the deposited materials intact to result in surface features for achieving superior hydrophobic properties.

U.S. Pat. No. 11,267,930 B2 describes a process of making an antimicrobial polymer composition. The process comprises mixing an antimicrobial additive into a polymeric material. The polymeric material comprises a polymeric backbone made up of a urethane linkage derived from a polyisocyanate and a polyol. The mixing occurs under conditions that result in the breaking of a minority of the urethane bonds resulting in reactive isocyanate groups. The reactive isocyanate groups react with react with the antimicrobial additive to covalently bond the additive into the polymer backbone resulting in an antimicrobial polymer composition.

It would, therefore, be beneficial to provide an bifunctional surface for antimicrobial applications which eliminates the problems described above. In particular, it would be beneficial to provide a bifunctional surface that has both antimicrobial properties as well as hydrophobic properties.

### SUMMARY OF THE INVENTION

An embodiment is directed a bifunctional surface for antimicrobial applications having a micro- or nano-textured surface.

An embodiment is directed to a bifunctional surface having a micro- or nano-textured structure made from a polymer composite comprising a mixture of a polymer and at least one antimicrobial additive and an optional hydrophobic additive

Another embodiment is directed to a bifunctional surface comprising a first layer comprising a polymer composite and an optional hydrophobic additive and a second layer applied to the first layer comprising an antimicrobial additive and an optional hydrophobic additive wherein the surface has a micro- or nano-textured structure.

Yet another embodiment is directed to a bifunctional surface comprising a first layer comprising a polymer composite comprising a polymer, an optional antimicrobial additive and an optional hydrophobic additive and a second layer applied to the first layer comprising an antimicrobial additive and a hydrophobic additive.

Other features and advantages of the present invention will be apparent from the following more detailed description of the illustrative embodiment, which illustrates, by way of example, the principles of the invention.

### DETAILED DESCRIPTION OF THE INVENTION

In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

Moreover, the features and benefits of the invention are illustrated by reference to the preferred embodiments. Accordingly, the invention expressly should not be limited to such embodiments illustrating some possible non-limiting combination of features that may exist alone or in other combinations of features, the scope of the invention being defined by the claims appended hereto.

The invention is directed to bifunctional surface for antimicrobial applications. The bifunctional surface not only prevents the adherence of bacteria but also ensures that any residual bacteria that can adhere to the surface is killed. The bifunctional surface has a micro- or nano-textured surface.

As used herein, the terms “polymer” or “polymeric” refer to a material that is a homopolymer, copolymer or terpolymer of the like.

As used herein, the term “antimicrobial” means any material that kills microorganisms or inhibits their growth. Preferably antimicrobial means a greater than 3 log reduction, preferably a greater than 4 log reduction, and more preferably a greater than 5 log reduction in a population of microbes relative to a control, according to ISO22196 test standard which is a recognized method to quantify the antimicrobial activity level of an antimicrobial surface (samples are exposed to bacteria for a 24 hours period at 37 degree C.). In a preferred embodiment, the term antimicrobial means a greater than 3 log reduction, preferably a greater than 4 log reduction, and more preferably a greater than 5 log reduction in a population of microbes relative to a control, measured after 12 hours, preferably after 6 hours, more preferably after 3 hours.

As used herein, the term “antifouling” refers to a material that prevents or retards the formation of a biofilm on a surface. The antifouling material may work by preventing or reducing the adhesion of microorganisms to the surface.

As used herein, the term “composite” refers a polymer matrix containing various additives.

In one embodiment, the invention is bifunctional surface comprising a polymer composite. The polymer composite includes a polymer, which is used as a matrix for the other ingredients in the composite. Non-limiting examples of polymers that maybe used in the composite include polyolefins, polyamides, polyesters, poly (meth)acrylates, polycarbonates, polyvinyl alcohols, polynitriles, polyacetals, polyimides, polyarylketones, polyetherketones, polyhydroxyalkanoates, polycaprolactones, polyurethanes, polysulfones, polyphenylene oxides, polyphenylene sulfides, polyacetates, liquid crystal polymers, fluoropolymers, ionomeric polymers, thermoplastic elastomers, and copolymers of any of them and combinations of any two or more of them.

Many commercial species of these categories of polymers exist that can be used as the polymer of the polymer composite. Non-limiting examples of specific commercial polymers include acrylonitrile butadiene styrene (ABS), polymethyl methacrylate (PMMA), cellulose acetate, cyclic olefin copolymer (COC), ethylene-vinyl acetate (EVA), ethylene methyl acrylate (EMA), ethylene vinyl alcohol (EVOH), polytetrafluoroethane (PTFE), ionomers, polyoxymethylene (POM or Acetal), polyacrylonitrile (PAN), polyamide 6, polyamide 6,6, polyamide-imide (PAI), polyaryletherketone (PAEK), polybutadiene (PBD), polybutylene (PB), polybutylene terephthalate (PBT), polycaprolactone (PCL), polychlorotrifluoroethylene (PCTFE), polyethylene terephthalate (PET), polycyclohexylene dimethylene terephthalate (PCT), polycarbonate (PC), polyhydroxybutyrate (PHB), polyethylene (PE), polyetheretherketone (PEEK), polyetherketoneketone (PEKK), polyetherimide (PEI), polyethersulfone (PES), chlorinated polyethylene (CPE), polyimide (PI), polylactic acid (PLA), polymethyipentene (PMP), polyphenylene oxide (PPO), polyphenylene sulfide (PPS), polyphthalamide (PPA), polypropylene (PP), polysulfone (PSU), polytrimethylene terephthalate (PTT), polyurethane (PU), polyvinyl acetate (PVA), and styrene-acrylonitrile (SAN).

The polymer composite includes at least one antimicrobial additive in this embodiment. Antimicrobial additives can be either inorganic antimicrobial additives or organic antimicrobial additives.

Inorganic antimicrobial additives are inorganic compounds which contain a metal or metal ions, such as silver, zinc, gold, platinum, palladium, tin, nickel, iron, copper and the like which have antimicrobial properties. The metal-containing species may be supported on an inorganic substance such as silica or like metal oxides, zeolite, synthetic zeolite, zirconium phosphate, calcium phosphate, calcium zinc phosphate, ceramics, soluble glass powders, alumina silicone, titanium zeolite, apatite, calcium carbonate and the like. Other metal-containing antimicrobial compounds include mercury acetates and organozinc compounds. The inorganic antimicrobial additive, if used in the polymer composite, comprises about from about 0.1% to about 10% by weight %, including from about 0.1% to about 8% or from about 0.5 to about 5% by weight of the composition of the polymer composite.

Organic antimicrobials are organic or organometalic compounds such as quaternary ammonium salts, phenols, alcohols, aldehydes, iodophores, poly quats (such as oligermeric poly quats derivatized from an ethylenically unsaturated diamine and an ethylenically unsaturated dihalo compound), biguanides, benzoates, 3-iodo-2-propynyl-n-butylcarbamatem, n-butyl-1,2-bezisothiazolin-3-one, parabens, sorbates, propionates, imidazolidinyl urea, 1-(3-chloroallyl)-3,5,7-triaza-1-azoniaadamantane chloride (Dowacil 200, Quaternium), isothiazolones, DMDM hydantoin (2,3-imidazolidinedione), phenoxyethanol, bronopol, fluoroquinolones (such as ciprofloxacin), “potent” beta-lactams (third and fourth generation cephalosporins, carbapenems), beta-lactam/beta-lactamase inhibitors, glycopeptides, aminoglycosides, antibiotic drugs, heparin, phosphorylcholine compounds, sulfobetaine, carboxybetaine, and organometallic compounds/complexes containing silver, zinc, palladium, platinum and copper. Additional examples of these organic antimicrobial agents includes pharmaceutical drugs such as penicillin, trichlosan, functional biguanides, mono-functional polyquaterniums, quaternized mono-functional polyvinylpyrrolidones (PVP), silane quaternary ammonium compounds, and other quaternized ammonium salts. If an organic antimicrobial additive is used in the antimicrobial polymer composite, it comprises about from 0.1% to about 10% by weight, including from about 0.1% to about 8% or from about 0.5% to about 5% by weight of the composition of polymer composite.

The antimicrobial additive may be preferably compounded with the polymer using an extruder, molding machine or other conventional compounding machine to form a polymer composite. The conditions for compounding and the time to compound the polymer and the antimicrobial additive are dependent upon which specific polymer and antimicrobial additives are chosen. Determining these conditions would be well within the scope of one of ordinary skill in the art.

The antimicrobial polymer composite can include an optional flame retardant. The flame retardant can be a non-halogenated phosphorus flame retardant; a halogenated flame retardant or an inorganic metal based flame retardant. Examples of non-halogenated phosphorus flame retardants include metal phosphinate salts, a metal diphosphinate salt, melamine cyanurate, melamine phosphate compounds, piperazine pyrophosphate, ammonium polyphosphates, red phosphorus, phosphate esters or combinations thereof. Inorganic metal based flame retardants include magnesium hydroxide, aluminum trihydroxide and zinc borate. Examples of halogenated flame retardants include polybrominated diphenyl ethers, deabromodiphenyl ethers or decabromodiphenyl ethane. If used in the composition, the flame retardant, the flame retardant makes up about 5% to about 50% by weight of the entire polymer composite, including from about 5% to about 40% or from about 10% to about 35% by weight of the entire polymer composite.

The polymer composite may include additional additives conventionally employed in the manufacture of products made from polymers. Suitable additives include pigments, dyes, voiding agents, antistatic agents, foaming agents, plasticizers, binders, radical scavengers, anti-blocking agents, anti-dust agents, antifouling agents, surface active agents, slip aids, optical brighteners, plasticizers, viscosity modifiers, gloss improvers, dispersion stabilizers, UV stabilizers, UV absorbers, antioxidants, lubricity agents, heat stabilizers, hydrolysis stabilizers, cross-linking activators, flame retardants, layered silicates, radio opacifiers, such as barium sulfate, tungsten metal, non-oxide bismuth salts, fillers, colorants, reinforcing agents, adhesion mediators, impact strength modifiers, antimicrobials, and any combination thereof. Such additives may be included in conventional amounts. Preferably, these additional additives are generally in the range of about 0.5% to 50%, including from about 0.5% to about 40% or from about 1% to about 30% by weight % of the composition of the polymer composite. These can be mixed into the polymer composite in any conventional manner desired, to achieve the desired properties in the polymer composite.

The bifunctional surface can optionally include a hydrophobic additive. The additive can be added to the polymer composite. Alternatively, the hydrophobic additive can be part of a second layer which comprises an antimicrobial additive which is applied to the polymer composite. Hydrophobic additives are additives that repel water. The mechanisms associated with liquid repellency and liquid adhesion are in part related to the surface energy acting between the liquid and the surface in contact with the liquid. When the free surface energy between the surface and the liquid is low, there is generally a weak bond or adhesion between the liquid and the surface. In such situations, the liquid has a greater tendency to run off the surface and/or be absorbed at a slower rate by the surface. When used as a coating for the polymer composite, it causes any water on the surface of the polymer composite to bead. The hydrophobic additive increases the anti-fouling and anti-dusting performance of any product made from the polymer composite having such a coating.

The hydrophobic additive can be any hydrophobic additive, or precursor(s) of said hydrophobic additive. Examples of suitable hydrophobic polymeric additives are the polymers with a surface advancing contact angle of water above 80 degees, such as for example, but not limited to polyamide 11, polyvinylidene fluoride, and polyvinyl fluoride. Preferably the additive is a polymers with a surface advancing contact angle of water above 90 degrees, such as for example, but not limited to polyethylene, polychlorotrifluoroethylene, polydimethylsiloxane, fluorinated ethylene propylene polymer, poly(tetrafluoroethylene). Examples of other hydrophobic additives that can be used, but are not limited to, hydrocarbon waxes such as paraffin wax, stearic acid, sodium octadecane-1-sulphonate, and trimethylstearylammonium chloride; fluorinated waxes such as but not limited to dialkyl amide perfluoropolyether derivatives, and hydrocarbon silicone waxes. An example of a hydrocarbon silicone wax is a triblock copolymer of ethylene and polydimethylsiloxane. Additional hydrophobic additives can also include, but are not limited to, fluoroalkylsilanes, polysiloxaes, fluorinated chemical and silane modified powders.

It may be advantageous to select a more hydrophobic additive, i.e. having a greater advancing contact angle of water on a flat, unstructured, surface, e.g. from 80 to 140°, preferably 90 to 140°. The amount of the hydrophobic additive is in the range of about 0.1% by weight to about 20% by weight, including from about 0.1% to about 5% by weight, 1°/0 to 10% by weight or from about 0.5% to about 5% by weight of the layer.

The bifunctional surface having a textured surface of micro or nano patterns can be fabricated using various type of methods. For example a micro- or nano-structured surface can be made by either 1) sequentially depositing a micro- or nano-structured material; 2) sequentially etching a surface to create a micro- and/or nano-structured surface followed; 3) depositing a micro- or nano-structured material that is itself hydrophobic; 4) depositing a coating followed by etching to create a micro- and/or nano-structured surface, 5) micro or nano-imprinting; or 6) injection molding or extrusion with a mold or die has micro or nano-textured surface.

Preferably, the bifunctional surface is formed after the product is extruded from the polymer composite. The term “textured surface” in the context of the present invention refers to the surface of the polymer composite of the invention or the surface of a polymer composite containing an antimicrobial additive coating or a polymer composite containing a coating of both an antimicrobial additive and a hydrophobic additive, having a plurality of micro- or nanometric protrusions, or having a plurality of hierarchical micro- and nanometric protrusions. The protrusions of the invention may have any common regular and/or irregular shapes, such as a spherical shape, elliptical shape, cubical shape, tetrahedral shape, pyramidal shape, octahedral shape, cylindrical shape, cylindrical shape, polygonal pillar-like shape, conical shape, columnar shape, tubular shape, helical shape, funnel shape, or dendritic shape. Each of the protrusions may have the same or different shape, height, and width. In a particular embodiment, the protrusions have a columnar shape or a conical shape.

In one embodiment, the protrusions in the textured surface present a height of between 5 nm and 1000 μm, preferably between 5 nm and 100 μm, more preferably of between 10 nm and 20 μm, more preferably between 50 nm and 10 μm, more preferably of between 100 nm and 500 nm, even more preferably between 200 nm and 400 nm, even more preferably between 250 and 300 nm. In another preferred embodiment, the protrusions in the textured surface present a height of between 1 μm and 12 μm.

In one embodiment, the protrusions in the textured surface of the invention present a width between 5 nm and 1000 μm, preferably between 5 nm and 100 μm, more preferably between 10 nm and 20 μm, more preferably of between 50 nm and 10 μm, more preferably of between 100 nm and 500 nm, even more preferably between 200 nm and 400 nm, even more preferably between 250 and 300 nm. In another preferred embodiment, the protrusions in the textured surface present a width of between 1 μm and 2 μm.

In one embodiment, the protrusions in the textured surface present an interval between the protrusions or pitch of between 5 nm and 1000 μm, preferably between 5 nm and 100 μm, more preferably of between 10 nm and 20 μm, more preferably of between 50 nm and 10 μm, more preferably of between 100 nm and 500 nm, even more preferably between 200 nm and 400 nm, even more preferably between 250 and 300 nm. In another preferred embodiment, the protrusions in the textured surface present an interval of between 1 μm and 4 μm. The intervals between the protrusions may also be the same or different.

Another embodiment of the invention is directed to a bifunctional surface for antimicrobial applications in which a first layer comprising a polymer composite is coated with an antimicrobial coating. The antimicrobial coating can optionally contain a hydrophobic additive.

The antimicrobial coating can be formed from at least one antimicrobial additive. This coating can optionally also include a hydrophobic additive. The coating can also have a resin/binder, solvent and other desirable additives. The resin/binder may include acrylic resins, alkyd resins, cellulose resins, polyester resins, polyurethanes, epoxy resins, hydrocarbon resins, methacrylic resins, phenolic resins, polyolefins, silicone resins, vinyl resins and fluorinated resins. The amount of the resin the coating is in the range of about 40 to about 98% by weight, including from about 50% to about 95%, or from 70 to about 90% by weight of the coating. In addition, the resin/binder may include fatty acids, natural waxes such as beeswax, carnauba wax, wool wax and also synthetic waxes such as amide waxes. Any solvent appropriate for the coating can be used. Preferred solvents include: water, alcohols, ketones, toluene, ethylbenzene, mixed xylene and high flash aromatic napthas. Preferably, the solvent is less than 20% by weight of the composition.

The antimicrobial coating can be prepared by any suitable method for preparing coatings which is dependent upon the components of the coating. Any known method can be used to apply the antimicrobial coating to the surface of the polymer composite, including but not limited to printing, brushing, spraying, rolling, spreading, dipping and the like. Generally, the coating is between 10 and 100 microns thick.

In yet another embodiment of the instant invention, a coating is made of at least one antimicrobial additive and at least one hydrophobic additive which are combined to form a single coating. This coating is used to coat a first polymer composite layer. The polymer composite layer can include optionally an antimicrobial additive and as well as an optional hydrophobic additive and other conventional additives. The coating can include a resin/binder and solvent as well as other additives used in the processing of a coating. Any conventional method can be used to obtain such a coating. Preferably, the coating is applied by any known method, including but not limited to printing, brushing, spraying, rolling, spreading, doctor blade coating, dipping and the like. The thickness of this single coating is preferably between 0.05 to 50 microns, including from about 0.1 to about 20 micrometers, or from about 0.1 to about 10 micrometers, so as to obtain the desired bifunctional surface.

The bifunctional surface or product containing the bifunctional surface of the instant invention, may then be subject to a crosslinker, especially if the product is a heat shrinkable product. A crosslinker is an agent or a substance that enables crosslinking of the material. The product of the invention can be optionally crosslinked through exposure to an agent such as heat, UV light, electron beam, or gamma-radiation with or without crosslinking agents or substances. If radiation is used, the product is exposed to radiation in the range of 50 KGy to 1100 KGy, preferably 50 to 300 KGy to obtain the desired crosslinking. Other crosslinking substances are chemicals, monomers or polymers having more than one homo- or hetero-functional group, capable of linking two or more binder polymer strands, two or more particles and capable of linking polymer strands and particles to each other and to the surface. In some embodiments of the present invention, the crosslinker has more than one radical generating moiety, such as aryl ketone, azide, peroxide, diazo, carbene or nitrene generator. In other embodiments, the crosslinker has more than one reactive group such as vinyl, carboxy, ester, epoxy, hydroxyl, amido, amino, thio, N-hydroxy succinimide, isocyanate, anhydride, azide, aldehyde, cyanuryl chloride or phosphine that can thermochemically react with functionalized binder polymer. In addition, the product of the instant invention can be crosslinked using radical generators. Radicals generators can form new bonds through radical-radical combination, addition to unsaturated bonds, hydrogen abstraction and subsequent recombination, as well as possible electron transfer reactions. Examples of radical initiators include benzophenone, acetophenone derivatives, peroxyides, peroxy compounds, benzoin derivatives, benzilketals, hydroxyalkylphenones and aminoalkylphenones, O-acyl oximoketones, acylphosphin oxides and acylphosphonates, thiobenzoic S-esters, azo and azide compounds, triazines, 1,2 diketones, quinones, coumarins, xanthones. The product is crosslinked preferably to obtain a crosslinking density of about 40 to about 150 psi, depending upon the final application of the product.

The crosslinked product having the coating of the instant invention forms a bifunctional surface having antimicrobial properties can be further formed into any desired shape, such as a sheets, pipes, profiles using standard manufacturing techniques for these products.

While the invention has been described with reference to a preferred embodiment, it will be understood by those skilled in the art that various changes may be made and equivalents may be substituted for elements thereof without departing from the spirit and scope of the invention as defined in the accompanying claims. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. A bifunctional surface having a micro- or nano-textured structure comprising a polymer composite comprising a mixture of a polymer and at least one antimicrobial additive and an optional hydrophobic additive.

2. The bifunctional surface of claim 1, wherein said polymer is chosen from the group consisting essentially of: include polyolefins, polyamides, polyesters, poly (meth)acrylates, polycarbonates, polyvinyl alcohols, polynitriles, polyacetals, polyimides, polyarylketones, polyetherketones, polyhydroxyalkanoates, polycaprolactones, polyurethanes, polysulfones, ethylene vinyl acetate, ethylene methyl acrylate, polyphenylene oxides, polyphenylene sulfides, polyacetates, liquid crystal polymers, fluoropolymers, ionomeric polymers, thermoplastic elastomers, and copolymers of any of them and combinations of any two or more of them.

3. The bifunctional surface of claim 1, wherein said antimicrobial additive is an inorganic antimicrobial additive is chosen from the group consisting essentially of: silver, zinc, gold, platinum, tin, nickel, iron, or copper or compounds containing silver, zinc, gold, platinum, tin, nickel, iron or copper.

4. The bifunctional surface of claim 1, wherein said antimicrobial additive is an organic antimicrobial additive is chosen from the group consisting essentially of: quaternary ammonium salts, phenols, alcohols, aldehydes, iodophores, poly quats, biguanides, benzoates, parabens, sorbates, propionates, imidazolidinyl urea, 1-(3-chloroallyI)-3,5,7-triaza-1-azoniaadamantane chloride (Dowacil 200, Quaternium), isothiazolones, DMDM hydantoin (2,3-imidazolidinedione), phenoxyethanol, bronopol, fluoroquinolones, beta-lactams, beta-lactam/beta-lactamase inhibitors, glycopeptides, aminoglycosides, antibiotic drugs, heparin, phosphorylcholine compounds, sulfobetaine, carboxybetaine, and organometallic compounds/complexes containing silver, zinc, gold, palladium, platinum and copper.

5. The bifunctional surface of claim 1, wherein said at least one hydrophobic additive is chosen from the group consisting essentially of hydrophobic polyesters, hydrophobic polyamides, hydrophobic polyurethanes, fluoropolymers, polyolefins, hydrophobic vinyl polymers and hydrophobic silicones, silicone rubbers, polysiloxanes, hydrocarbon waxes, fluorinated waxes, hydrocarbon silicone waxes, fluoroalkylsilanes, poly(tetrafluoroethylene) (PTFE) and silicone elastomers.

6. The bifunctional surface of claim 1, wherein the micro or nano-textured structure is about 10 nanometers to about 1000 micrometers.

7. The bifunctional surface of claim 1, wherein the hydrophobic additive is a polymer with a surface having an advancing water contact angle above 80 degrees.

8. A bifunctional surface having a micro- or nano-textured structure comprising: a first layer comprising a polymer composite comprising a polymer and an optional hydrophobic additive; a second layer applied to the top of the first layer comprising an antimicrobial additive and an optional hydrophobic additive.

9. The bifunctional surface of claim 8, wherein said polymer is chosen from the group consisting essentially of: include polyolefins, polyamides, polyesters, poly (meth)acrylates, polycarbonates, poly(vinyl halides), polyvinyl alcohols, polynitriles, polyacetals, polyimides, polyarylketones, polyetherketones, polyhydroxyalkanoates, polycaprolactones, polystyrenes, polyurethanes, polysulfones, ethylene vinyl acetate, ethylene methyl acrylate, polyphenylene oxides, polyphenylene sulfides, polyacetates, liquid crystal polymers, fluoropolymers, ionomeric polymers, thermoplastic elastomers, and copolymers of any of them and combinations of any two or more of them.

10. The bifunctional surface of claim 8, wherein said antimicrobial additive is an inorganic antimicrobial additive is chosen from the group consisting essentially of: silver, zinc, gold, platinum, palladium, tin, nickel, iron, or copper or compounds containing silver, zinc, gold, platinum, tin, nickel, iron or copper.

11. The bifunctional surface of claim 8, wherein said antimicrobial additive is an organic antimicrobial additive is chosen from the group consisting essentially of: quaternary ammonium salts, phenols, alcohols, aldehydes, iodophores, poly quats, biguanides, benzoates, parabens, sorbates, propionates, imidazolidinyl urea, 1-(3-chloroallyl)-3,5,7-triaza-1-azoniaadamantane chloride (Dowacil 200, Quaternium), isothiazolones, DMDM hydantoin (2,3-imidazolidinedione), phenoxyethanol, bronopol, fluoroquinolones, beta-lactams, beta-lactam/beta-lactamase inhibitors, glycopeptides, aminoglycosides, antibiotic drugs, heparin, phosphorylcholine compounds, sulfobetaine, carboxybetaine, and organometallic compounds/complexes containing silver, zinc, gold, palladium, platinum and copper.

12. The bifunctional surface of claim 8, wherein said at least one hydrophobic material is chosen from the group consisting essentially of hydrophobic polyesters, hydrophobic polyamides, hydrophobic polyurethanes, fluoropolymers, polyolefins, hydrophobic vinyl polymers and hydrophobic silicones, silicone rubbers, polysiloxanes, hydrocarbon waxes, fluorinated waxes, hydrocarbon silicone waxes, fluoroalkylsilanes, poly(tetrafluoroethylene) (PTFE) and silicone elastomers.

13. The bifunctional surface of claim 8, wherein the micro or nano-textured structure is about 10 nanometers to about 1000 micrometers.

14. The bifunctional surface of claim 8, wherein the hydrophobic additive is a polymer with a surface having an advancing water contact angle above 80 degrees.

15. A bifunctional surface comprising a first layer comprising a polymer composite comprising a polymer, an optional antimicrobial additive and an optional hydrophobic additive, and a second layer applied to said first layer comprising an antimicrobial additive and a hydrophobic additive.

16. The bifunctional surface of claim 15, wherein said polymer is chosen from the group consisting essentially of: include polyolefins, polyamides, polyesters, poly (meth)acrylates, polycarbonates, polyvinyl alcohols, polynitriles, polyacetals, polyimides, polyarylketones, polyetherketones, polyhydroxyalkanoates, polycaprolactones, polyurethanes, polysulfones, ethylene vinyl acetate, ethylene methyl acrylate, polyphenylene oxides, polyphenylene sulfides, polyacetates, liquid crystal polymers, fluoropolymers, ionomeric polymers, thermoplastic elastomers, and copolymers of any of them and combinations of any two or more of them.

17. The bifunctional surface of claim 15, wherein said hydrophobic additive is chosen from the group consisting essentially of hydrophobic polyesters, hydrophobic polyamides, hydrophobic polyurethanes, fluoropolymers, polyolefins, hydrophobic vinyl polymers and hydrophobic silicones, silicone rubbers, polysiloxanes, hydrocarbon waxes, fluorinated waxes, hydrocarbon silicone waxes, fluoroalkylsilanes, poly(tetrafluoroethylene) (PTFE) and silicone elastomers.

18. The bifunctional surface of claim 15, wherein said antimicrobial additive is an inorganic antimicrobial additive is chosen from the group consisting essentially of: silver, zinc, gold, platinum, tin, nickel, iron, or copper or compounds containing silver, zinc, gold, platinum, palladium, tin, nickel, iron or copper.

19. The bifunctional surface of claim 15, wherein said antimicrobial additive is an organic antimicrobial additive is chosen from the group consisting essentially of: quaternary ammonium salts, phenols, alcohols, aldehydes, iodophores, poly quats, biguanides, benzoates, parabens, sorbates, propionates, imidazolidinyl urea, 1-(3-chloroallyl)-3,5,7-triaza-1-azoniaadamantane chloride (Dowacil 200, Quaternium), isothiazolones, DMDM hydantoin (2,3-imidazolidinedione), phenoxyethanol, bronopol, fluoroquinolones, beta-lactams, third and fourth generation cephalosporins, carbapenems, beta-lactam/beta-lactamase inhibitors, glycopeptides, aminoglycosides, antibiotic drugs, heparin, phosphorylcholine compounds, sulfobetaine, carboxybetaine, and organometallic compounds/complexes containing silver, zinc, gold, palladium, platinum and copper.

20. The bifunctional surface of claim 1, wherein the polymer composite further comprises a flame retardant, an antioxidant and a crosslinker.
